(19) United States
(12) Patent Application Publication
(10) Pub. No.: US 2022/0288764 A1
(43) Pub. Date: Sep. 15, 2022

(54) ROBUST COMMUNICATION

(71) Applicant: Hilti Aktiengesellschaft, Schaan (LI)

(72) Inventors: Klaus HAUSER, Schwabmuenchen (DE); David KOSCHECK, Augsburg (DE); Stefan MAYER, Hurlach (DE); Michael CANDUSSIO, Olching (DE)

(21) Appl. No.: 17/638,993

(22) PCT Filed: Sep. 14, 2020
(86) PCT No.: PCT/EP2020/075637

§ 371 Date: Feb. 28, 2022

(30) Foreign Application Priority Data
Sep. 23, 2019 (EP) 19198849.2

(51) Int. Cl. B25F 5/02; H01M 50/247; H01M 10/42

(52) U.S. Cl. CPC B25F 5/02; H01M 50/247; H01M 10/425; H01M 2220/30; H01M 2010/4278

(57) ABSTRACT

A power tool with at least one control device and at least one communication circuit for exchanging signals in a half-duplex mode with a first and a second communication line for differential communication between at least a first transceiver and a second transceiver. A system including a power tool with at least one control device and a rechargeable battery with at least one set of control electronics, the rechargeable battery being designed for supplying the power tool with electrical energy. The system includes at least one communication circuit for exchanging signals in a half-duplex mode with a first and a second communication line for differential communication between at least a first transceiver and a second transceiver.

The present invention relates to a power tool with at least one control device.

The present invention also relates to a system comprising a power tool with at least one control device and a rechargeable battery with at least one set of control electronics, the battery being designed for supplying the power tool with electrical energy.

### BACKGROUND

Modern power tools, such as for example hammer drills, saws, grinders or the like, nowadays have numerous components (for example a motor unit, transmission unit, transceiver, microcontroller, etc.) that exchange a great amount of information and data in the form of signals. A high level of information and data exchange now takes place in particular between a power tool and a rechargeable battery provided as a power supply.

Various communication networks or communication circuits are used for exchanging data (i.e. sending and receiving information). The communication between the individual components, i.e. the data exchange, usually takes place without any problem when the power tool is in an inoperative state. In the inoperative state, the power tool is not activated and the drive is only supplied with relatively little electrical energy (i.e. low current values or current intensity).

By contrast, in an operative mode of the power tool, a relatively great amount of electrical energy (i.e. high current values or current intensity) is supplied in order to produce a high power output of the power tool.

### SUMMARY OF THE INVENTION

However, high current values, and especially relatively rapidly changing current values (i.e. great fluctuation), produce unwanted interference coupling (for example inductive coupling, capacitive coupling, electromagnetic radiation and/or line-bound interference) on a neighboring signal line in the communication network. Since the technical measures for suitable interference immunity on the communication networks usually cause a considerable amount of effort and increased costs, a consequence of this is to dispense with communication between the components during operation (i.e. in the active mode) of the power tool.

An object of the present invention is therefore to provide a power tool and also a system comprising a power tool and a rechargeable battery with which the aforementioned problem is solved and robust communication can be achieved during the operation of the power tool or the system.

The present invention provides a power tool with at least one control device.

According to the invention, the power tool comprises at least one communication circuit for exchanging signals in a half-duplex mode with a first and a second communication line for differential communication between at least a first transceiver and a second transceiver. This makes robust communication that is immune to interference possible even during the operation of the power tool.

The transceiver component may also be referred to as a transmitter-receiver or a microcontroller. In addition, it is also possible that, instead of a first and a second transceiver, a first and a second control unit or a microcontroller or a first and a second microcontroller is/are correspondingly provided for the differential communication.

According to an advantageous embodiment of the present invention, it may be possible that, in the case of differential communication, there is a first differential voltage of between 1.5 and 3 V for a first state and a second differential voltage of between −0.5 and 0.5 V for a second state. The first voltage difference may correspond in particular to a value of 2 V and the second voltage difference may correspond in particular to a value of 0 V.

In the case of differential communication, the first state may also be referred to as the dominant or high state. Furthermore, in the case of differential communication, the second state may also be referred to as the recessive or low state.

According to an advantageous embodiment of the present invention, it may be possible that at least one rechargeable battery is provided as a power supply for the power tool and a maximum voltage value in the first state is up to 12 V with respect to the ground potential of the rechargeable battery.

The ground potential of the rechargeable battery may also be referred to as ground, potential zero or mass.

According to an advantageous embodiment of the present invention, it may be possible that the at least first transceiver is positioned in the power tool and the at least second transceiver is positioned in the rechargeable battery.

The present invention also provides a system comprising a power tool with at least one control device and a rechargeable battery with at least one set of control electronics, the rechargeable battery being designed for supplying the power tool with electrical energy.

According to the invention, it comprises at least one communication circuit for exchanging signals in a half-duplex mode with a first and a second communication line for differential communication between at least a first transceiver and a second transceiver. This makes robust communication that is immune to interference possible even during the operation of the system.

The transceiver component may also be referred to as a transmitter-receiver or a microcontroller. In addition, it is also possible that, instead of a first and a second transceiver, a first and a second control unit or a microcontroller or a first and a second microcontroller is/are correspondingly provided for the differential communication.

According to an advantageous embodiment of the present invention, it may be possible that the at least first transceiver is positioned in the power tool and the at least second transceiver is positioned in the rechargeable battery.

According to an advantageous embodiment of the present invention, it may be possible that both the at least first transceiver and the at least second transceiver are positioned in the power tool.

According to an advantageous embodiment of the present invention, it may be possible that, in the case of differential communication, there is a first differential voltage of between 1.5 and 3 V for a first state and a second differential voltage of between −0.5 and 0.5 V for a second state.

In the case of differential communication, the first state may also be referred to as the dominant or high state. Furthermore, in the case of differential communication, the second state may also be referred to as the recessive or low state.

According to an advantageous embodiment of the present invention, it may be possible that a maximum voltage value in the first state is up to 12 V with respect to the ground potential of the rechargeable battery.

The first and second communication lines for differential communication between the rechargeable battery and the power tool are component parts of a communication system. In this case, the communication system can be configured as a CAN data bus. However, it is also possible to use some other suitable communication system for differential communication between the rechargeable battery and the power tool.

Further advantages can be found in the following description of the figures. Various exemplary embodiments of the present invention are shown in the figures. The figures, the description and the claims contain numerous features in combination. A person skilled in the art will expediently also consider the features individually and combine them to produce useful further combinations.

### BRIEF DESCRIPTION OF THE DRAWINGS

In the figures:

FIG. 1 shows a cross section through a system according to the invention comprising a power tool with a connected rechargeable battery as a power supply;

FIG. 2 shows a cross section through a base part of the power tool according to the invention with a connected rechargeable battery;

FIG. 3 shows a first graphic representation of the various voltage levels in a first and a second state in the case of differential communication in the system according to the invention;

FIG. 4 shows a second graphic representation of the various voltage levels in the first and the second state in the case of differential communication in the system according to the invention; and

FIG. 5 shows a third graphic representation of the various voltage levels in the first and the second state in the case of differential communication in the system according to the invention.

### DETAILED DESCRIPTION

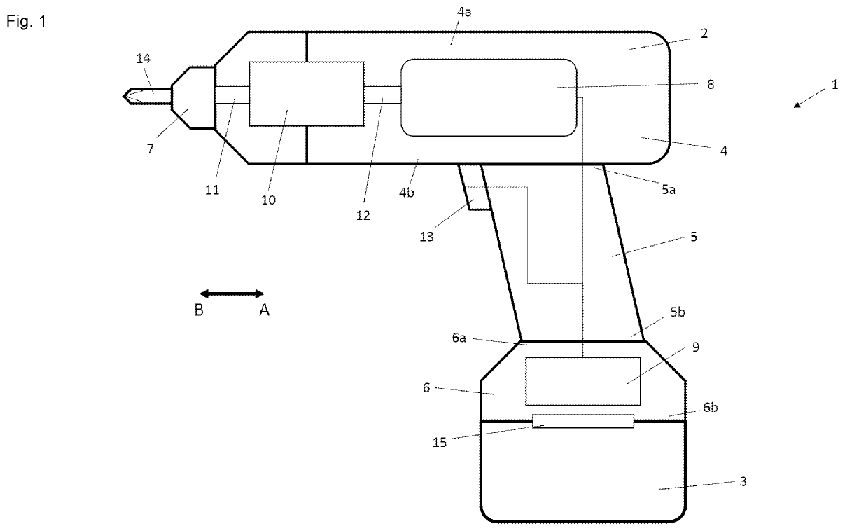

FIG. 1 illustrates a system 1 according to the invention with a power tool 2 and a rechargeable battery 3. The rechargeable battery 3 is connected to the power tool and serves for supplying the electrical loads of the power tool 2 with electrical energy. During the supply, electric current flows from the rechargeable battery 3 to the power tool 2. The rechargeable battery may also be referred to as a power pack or a battery.

According to an alternative embodiment of the present invention, the power tool 2 may not be supplied with electrical energy by a rechargeable battery but by a network connection. The network connection may also be referred to as a power cable. This alternative embodiment of the present invention is not shown in the figures.

As illustrated in FIG. 1, the power tool 2 is shown in the form of a rechargeable battery-operated screwdriver. According to other alternative embodiments, the power tool 2 may also be designed in the form of a power drill, a saw, a grinder or the like.

The power tool 2 designed as a rechargeable battery-operated screwdriver substantially comprises a housing 4, a handle 5, a base part 6, a tool fitting 7, an electrical drive 8 in the form of an electric motor, a control device 9, a transmission 9a, an input shaft 11, an output shaft 12 and an activation switch 13.

The electrical drive 8 designed as an electric motor, the transmission 10, the input shaft 11, the output shaft 12 and the control device 9 are positioned in the housing 4. The drive 8, the transmission 10, the input shaft 11 and the output shaft 12 are positioned in relation to one another and in the housing 10 such that a torque generated by the drive 8 is transmitted to the output shaft 12. The output shaft 12 transmits the torque to the transmission 10, which in turn passes on a torque to the input shaft 11. The tool fitting 7 is driven by way of the input shaft 11 by the transmission of the torque. As illustrated in FIG. 1, a tool 14 in the form of a bit is held in the tool fitting 7. By means of the bit, a screw can be screwed into a material. Neither the screw nor the material is illustrated in the figures.

As also shown in FIG. 1, the housing 4 comprises an upper side 4a and an underside 4b. The handle 5 comprises a first end 5a and a second end 5b. The first end 5a of the handle 5 is secured to the underside 4b of the housing 4. Furthermore, the base part 6 comprises an upper end 6a and a lower end 6b. The upper end 6a of the base part 6 is secured to the second end 5b of the handle 5. The lower end 6b of the base part 6 comprises a mechanical, electrical and electronic interface 15 and serves for mechanical, electrical and electronic connection to the rechargeable battery 3. For the purpose of taking up electric current, the interface 15 comprises a number of power connections 16. The interface 15 additionally comprises data connections 17 for transmitting and receiving signals between the power tool 2 and the rechargeable battery 3.

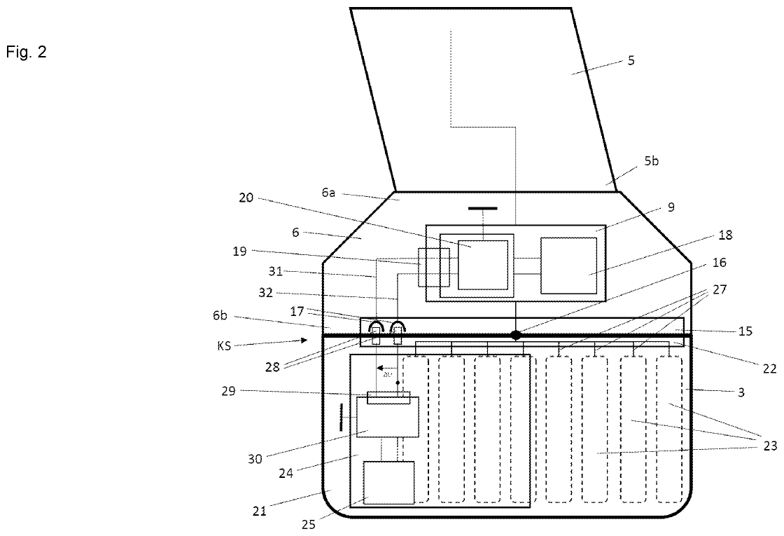

As can be seen from FIGS. 1 and 2, the control device 9 of the power tool 2 is positioned in the base part 6 of the power tool 2. The control device 9 of the power tool 2 serves for open-loop and closed-loop control of various processes in relation to the power tool 2 and in relation to the rechargeable battery 3. The control device 9 controls in particular the current or the intensity of the current that flows from the rechargeable battery 3 to the power tool 2, and in particular is used for driving the drive 8 formed as an electric motor.

The control device 9 of the power tool 2 in this case comprises a microcontroller 18 (see FIG. 2 for example, referred to as an MCU) and also a data interface 19 with a first transceiver 20 as a component part of a communication circuit KS for differential communication between the rechargeable battery 3 and the power tool 2. The data interface 19 of the power tool 2 is in this case one of altogether two data interfaces with the communication circuit KS for the differential communication between the rechargeable battery 3 and the power tool 2. As also described below, the rechargeable battery 3 comprises the other of the two data interfaces 29.

The rechargeable battery 3 substantially comprises a housing 21 with a rechargeable battery interface 22. In the housing 21 of the rechargeable battery 3 there are a multiplicity of energy storage cells 23 and also a set of control electronics 24 with a microcontroller 25.

The rechargeable battery 3 also comprises a data interface 29 with a second transceiver 30 as a component part of a communication circuit KS for differential communication between the rechargeable battery 3 and the power tool 2.

The energy storage cells 23 may also be referred to as rechargeable battery cells and serve for taking up, storing and providing electrical energy or an electrical voltage.

The rechargeable battery interface 22 is positioned on one side of the housing 21. The rechargeable battery interface 22 comprises a number of power connectors 27 for taking up and delivering electric current and also data connectors 28 for transmitting and receiving signals between the power tool 2 and the rechargeable battery 3. The electric current from the energy storage cells 23 can be delivered by way of the power connectors 27.

As shown in FIGS. 1 and 2, the power connectors 27 of the rechargeable battery 3 are connected to the power connections 16 of the power tool 2. Similarly, the data connectors 28 of the rechargeable battery 3 are connected to the data connections 17 of the power tool 2.

Through the connection, electric current can flow from the energy storage cells 23 of the rechargeable battery 3 to the power tool 2. Furthermore, signals can be exchanged for communication between the rechargeable battery 3 and the power tool 2.

As can be seen from FIG. 1, the activation switch 13 is positioned on a front side 5c of the handle 5. As a result of the activation switch 13 being moved in direction A, a signal can be transmitted from the activation switch 13 to the controller 9, as a result of which the controller 9 in turn transmits a signal to the control electronics 24 of the rechargeable battery 3. The signal transmitted to the control electronics 24 enables the release of electrical energy or electric current with a specific current value from the rechargeable battery 3 for the electrical load of the power tool 2 and in particular the drive 8 formed as an electric motor. The power tool 2 has a current device with which the current intensity of the supply current can be measured. If a supply current with a permissible current intensity is measured, the supply current can flow to the electrical loads of the power tool 2. Alternatively or additionally, the current measuring device may also be positioned in the rechargeable battery 3.

In order to transmit a signal corresponding to the travel of the activation switch 13 in direction A to the controller 9, the activation switch 13 comprises a potentiometer.

If the activation switch 13 moves again in direction B, a corresponding signal is transmitted to the controller 9 by means of the potentiometer, with the result that electric current (and consequently electrical energy) no longer flows from the rechargeable battery 3 to the power tool 2.

The differential communication between the rechargeable battery 3 and the power tool 2 takes place by way of a communication circuit KS. To participate in the communication circuit KS, both the rechargeable battery 3 and the power tool 2 respectively comprise a data interface 19, 29 with a transceiver 20, 30. The transceivers 20, 30 may in this case be designed as CAN transceivers. As indicated in FIG. 2, the transceiver 20 of the power tool is connected to the transceiver 30 of the rechargeable battery 3 by way of the data interface and a first communication line 31 (also referred to as COM high line) and a second communication line 32 (also referred to as COM low line) and the data interface 29.

According to an alternative embodiment of the present invention, the communication circuit KS with a first and a second transceiver may merely be positioned in the housing 4 of the power tool 2. As a result, the differential communication merely takes place within the power tool, i.e. between components of the power tool 2.

The transceiver 20 of the power tool 2 can transmit signals (for example a bit) by way of the data interface 19 and the first and second communication lines 31, 32 to the data interface 29 and the transceiver 30 of the rechargeable battery 3.

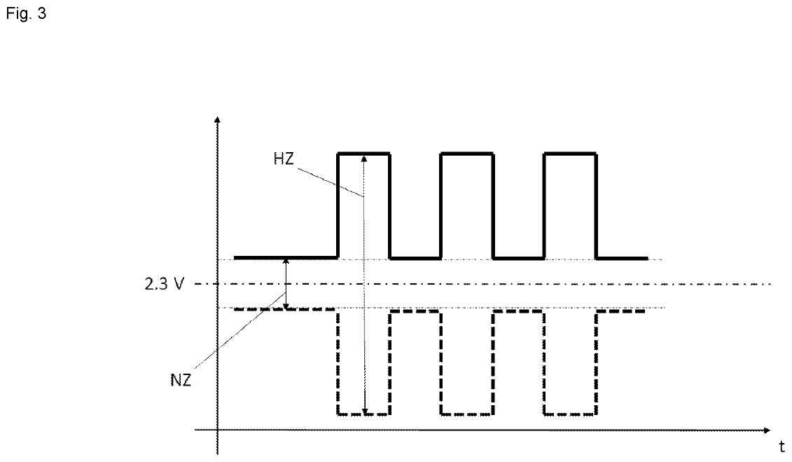

As illustrated in FIGS. 3 to 5, for transmitting a signal in the form of a bit by way of the communication circuit KS, both the COM high line 31 and the COM low line 32 are set to a first state HZ. The first state HZ for the COM high line 31 and the COM low line 32 is the high state, i.e. at which there is a first differential voltage of between 1.5 and 3 V. In the exemplary embodiment in FIG. 3, the first differential voltage for the first (high) state HZ is in this case 3 V.

The second state NZ for the COM high line 31 and for the COM low line 32 is the low state, i.e. at which there is a second differential voltage of between −0.5 and 0.5 V. An optimum value for the second differential voltage is in this case 0 V. In the exemplary embodiment in FIG. 3, the second differential voltage for the second (low) state NZ is 0.5 V.

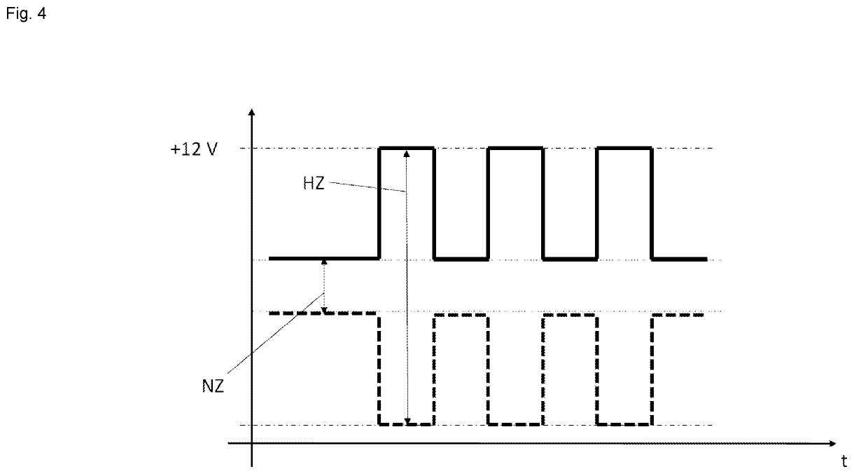

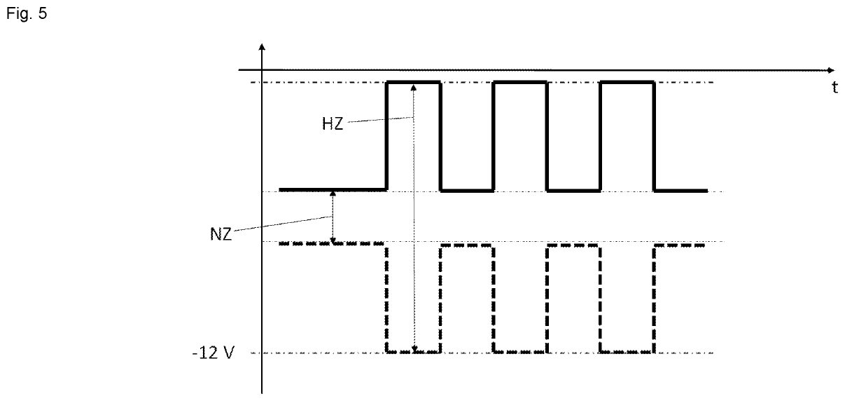

As correspondingly illustrated in FIGS. 4 and 5, the maximum voltage value in the first state may be up to 12 V (i.e. −12 V or +12 V) with respect to the ground potential of the rechargeable battery 3.

1-9. (canceled)

10. A power tool comprising:
at least one control device; and
at least one communication circuit for exchanging signals in a half-duplex mode with a first and a second communication line for differential communication between at least a first transceiver and a second transceiver.

11. The power tool as recited in claim 10 wherein the differential communication has a first differential voltage of between 1.5 and 3 V for a first state and a second differential voltage of between −0.5 and 0.5 V for a second state.

12. The power tool as recited in claim 11 wherein the at least one rechargeable battery is provided as a power supply for the power tool and a maximum voltage value in the first state is up to 12 V with respect to the ground potential of the rechargeable battery.

13. The power tool as recited in claim 12 wherein the first transceiver is positioned in the power tool and the second transceiver is positioned in the rechargeable battery.

14. A system comprising:
a power tool with at least one control device;
a rechargeable battery with at least one set of control electronics, the rechargeable battery being designed for supplying the power tool with electrical energy; and
at least one communication circuit for exchanging signals in a half-duplex mode with a first and a second communication line for differential communication between at least a first transceiver and a second transceiver.

15. The system as recited in claim 14 wherein the first transceiver is positioned in the power tool and the second transceiver is positioned in the rechargeable battery.

16. The system as recited in claim 14 wherein both the first transceiver and the at least second transceiver are positioned in the power tool.

17. The system as recited in claim 14 wherein the differential communication, has a first differential voltage of between 1.5 and 3 V for a first state and a second differential voltage of between −0.5 and 0.5 V for a second state.

18. The system as recited in claim 14 wherein the maximum voltage value in the first state is up to 12 V with respect to the ground potential of the rechargeable battery.
